(19) United States
(12) Patent Application Publication
(10) Pub. No.: US 2024/0222622 A1
(43) Pub. Date: Jul. 4, 2024

(54) POSITIVE ELECTRODE ACTIVE MATERIAL, METHOD FOR PRODUCING POSITIVE ELECTRODE ACTIVE MATERIAL, AND SOLID-STATE BATTERY

(71) Applicant: TOYOTA JIDOSHA KABUSHIKI KAISHA, Toyota-shi (JP)

(72) Inventor: Issei SUGIYAMA, Susono-shi (JP)

(73) Assignee: TOYOTA JIDOSHA KABUSHIKI KAISHA, Toyota-shi, (JP)

(21) Appl. No.: 18/527,479

(22) Filed: Dec. 4, 2023

(30) Foreign Application Priority Data
Dec. 27, 2022 (JP) 2022-210673

(51) Int. Cl. H01M 4/525; H01M 4/04; H01M 4/36; H01M 4/485; H01M 4/505; H01M 10/052

(52) U.S. Cl. CPC H01M 4/525; H01M 4/0402; H01M 4/366; H01M 4/485; H01M 4/505; H01M 10/052; H01M 2004/028

(57) ABSTRACT

The positive electrode active material is a positive electrode active material in which a layer_{O3} having a crystal structure of an O3-type structure and a layer_{O2} having at least one type of crystal structure selected from the group consisting of an O2-type structure, a T #2-type structure, and an O6-type structure are alternately laminated, wherein a volume of the layer_{O2} with respect to a total volume of the layer_{O3} and the layer_{O2} is 0.1 or more and 0.6 or less.

### CROSS-REFERENCE TO RELATED APPLICATION

This application is based on and claims priority under 35 USC 119 from Japanese Patent Application No. 2022-210673 filed on Dec. 27, 2022, the disclosure of which is incorporated by reference herein.

### BACKGROUND

### Technical Field

The present disclosure relates to a positive electrode active material, a method for producing a positive electrode active material, and a solid-state battery.

### Related Art

A positive electrode active material having at least one type of crystal structure selected from the group consisting of an O2-type structure, a T #2-type structure, and an O6-type structure is stable up to a high potential, and therefore has a large charge/discharge capacity in charging/discharging in a high potential range.

Japanese Patent Application Laid-Open (JP-A) No. 2014-186937 proposes “a positive electrode active material used for a nonaqueous electrolyte secondary battery, the positive electrode active material for a nonaqueous electrolyte secondary battery having a layered structure and including a lithium-containing transition metal oxide in which a main arrangement of a transition metal, oxygen, and lithium is represented by an O2 structure, and the lithium-containing transition metal oxide having Li, Mn, and element(s) M in a lithium-containing transition metal layer in the layered structure and being represented by a general composition formula of Liₓ[Li_{α}(MnₐM_{b})_{1-α}]O₂, wherein, in the formula, 0.5<x<1.1. 0.1<α<0.33, 0.67<a<0.97, 0.03<b<0.33, and M includes at least one element selected from the group consisting of Ni, Mg, Ti, Fe, Sn, Zr, Nb, Mo, W, and Bi”.

A positive electrode active material having at least one type of crystal structure selected from the group consisting of an O2-type structure, a T #2-type structure, and an O6-type structure tends to have poor quick charging/discharging performance because its internal diffusion rate of lithium ions is slow.

In recent years, there have been demands for improvement in quick charging/discharging performance, and development of positive electrode active materials having at least one type of crystal structure selected from the group consisting of an O2-type structure, a T #2-type structure, and an O6-type structure, with which batteries having excellent quick charging/discharging performance and having a large discharge capacity in a high potential range can be obtained, has been demanded.

### SUMMARY

Therefore, a problem to be solved by one exemplary embodiment of the present disclosure is to provide a positive electrode active material, with which a battery having excellent quick charging/discharging performance and having a large discharge capacity in a high potential range can be obtained.

A problem to be solved by another exemplary embodiment of the present disclosure is to provide a solid-state battery having excellent quick charging/discharging performance and having a large discharge capacity in a high potential range.

A problem to be solved by another exemplary embodiment of the present disclosure is to provide a method of producing a positive electrode active material, with which a battery having excellent quick charging/discharging performance and having a large discharge capacity in a high potential range can be obtained.

Means for solving the aforementioned problems include the following means.

<1> A positive electrode active material in which a layer_{O3} having a crystal structure of an O3-type structure and a layer_{O2} having at least one type of crystal structure selected from the group consisting of an O2-type structure, a T #2-type structure, and an O6-type structure are alternately laminated,
wherein a volume of the layer_{O2} with respect to a total volume of the layer_{O3} and the layer_{O2} is 0.1 or more and 0.6 or less.
   <2> The positive electrode active material according to <1>, wherein an average value of intensities at all midpoints between two adjacent peaks with respect to an average value of all peak maximum intensities in an intensity profile obtained by integrating respective pixel values in a direction perpendicular to a c-axis in a high-angle annular dark-field scanning transmission electron microscope image with an electron beam incidence direction being set as <1-10> is 0.05 or less.
   <3> A solid-state battery including the positive electrode active material according to <1> or <2>.
   <4> A method for producing a positive electrode active material, the method including: ion-exchanging Na contained in a compound represented by the following Formula 2 with Li:

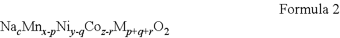

wherein, in Formula 2:
c, x, y, z, p, q and r are numbers satisfying 0.82<c, x+y+z=1, and 0<p+q+r≤0.20, and
M represents a metallic element selected from the group consisting of Li, B, Mg, Al, K, Ca, Ti. Cr, Ga, Zr, Nb, Mo and W.

According to an exemplary embodiment of the present disclosure, a positive electrode active material, with which a battery having excellent quick charging/discharging performance and having a large discharge capacity in a high potential range can be obtained, is provided.

According to another exemplary embodiment of the present disclosure, a solid-state battery having excellent quick charging/discharging performance and having a large discharge capacity in a high potential range is provided.

According to another exemplary embodiment of the present disclosure, a method for producing a positive electrode active material, with which a battery having excellent quick charging/discharging performance and having a large discharge capacity in a high potential range can be obtained, is provided.

### DETAILED DESCRIPTION

Hereinafter, exemplary embodiments, which are examples of the present disclosure, will be described. These descriptions and examples are intended to illustrate the exemplary embodiments and not to limit the scope of the invention.

In numerical ranges described in a stepwise manner in the present specification, an upper limit value or a lower limit value described in one numerical range may be replaced by an upper limit value or a lower limit value of another numerical range described in a stepwise manner. Furthermore, in the numerical ranges described in the present specification, the upper limit value or the lower limit value of the numerical range may be replaced with a value shown in the examples.

Each component may include plural types of substances that correspond thereto.

When referring to amounts of respective components in a composition, in a case in which plural types of substances that correspond to the respective components are present in the composition, unless otherwise specified, this means a total amount of the plural types of substances present in the composition.

The term “step” includes not only independent steps, but also those when the intended action of the step is achieved even if it cannot be clearly distinguished from other steps.

### Positive Electrode Active Material

In the positive electrode active material according to the present disclosure, a layer _{O3} having a crystal structure of an O3-type structure and a layer _{O2} having at least one type of crystal structure selected from the group consisting of an O2-type structure, a T #2-type structure, and an O6-type structure are alternately laminated.

Due to the aforementioned configuration, the positive electrode active material according to the present disclosure becomes a positive electrode active material, with which a battery having excellent quick charging/discharging performance and having a large discharge capacity in a region including a high potential region can be obtained. The reason for this is presumed to be as follows. It should be noted that excellent quick charging/discharging performance means that a charging rate is 70% or more at a current value of 5 C. Furthermore, a region including a high potential region refers to a region with a range of 2.0 V or more and including a region with 4.5 V or more, and is preferably a range of 2.0 V or more and 4.8 V or less.

The positive electrode active material according to the present disclosure has a layer_{O2} having at least one type of crystal structure selected from the group consisting of an O2-type structure, a T #2-type structure, and an O6-type structure. As a result, it has a large charge/discharge capacity in charging/discharging in the region including a high potential region. Furthermore, the positive electrode active material according to the present disclosure has a layer_{O3} having a crystal structure of an O3-type structure. The crystal structure of the O3-type structure is advantageous for improving the quick charging/discharging performance because of a high internal diffusion rate of lithium ions. Further, since the layer_{O3} and the layer_{O2} are alternately laminated, both the quick charging/discharging performance and the discharge capacity in the region including a high potential region are improved.

Furthermore, by setting a volume of the layer_{O2} to 0.1 or more and 0.6 or less with respect to a total volume of the layer_{O3} and the layer_{O2}, the quick charging/discharging performance and the discharge capacity in the region including a high potential region can be more easily improved.

### Layer_{O3}

The positive electrode active material according to the present disclosure has a layer_{O3} having a crystal structure of an O3-type structure.

Here, the crystal structure of the O3-type structure is a crystal structure belonging to the space group R-3m, in which lithium is present at the center of an oxygen octahedron, and three types of overlap between oxygen and a transition metal oxide are present per unit cell. It is preferably a crystal structure in which one period is formed by an oxygen 6 layer, an Li 3 layer, and a transition metal 3 layer.

### Layer_{O2}

The positive electrode active material according to the present disclosure has a layer_{O2} having at least one type of crystal structure selected from the group consisting of an O2-type structure, a T #2-type structure, and an O6-type structure.

Here, the crystal structure of the O2-type structure is a crystal structure belonging to the space group P63mc, in which lithium is present at the center of an oxygen octahedron, and in which two types of overlap between oxygen and a transition metal are present per unit cell. It is preferably a crystal structure in which one period is formed by an oxygen 4 layer, an Li 2 layer, and a transition metal 2 layer.

The crystal structure of the T #2-type structure is a crystal structure belonging to the space group Cmca, in which lithium is present at the center of an oxygen tetrahedron, and two types of overlap between oxygen and a transition metal are present per unit cell. It is preferably a crystal structure in which one period is formed by an oxygen 4 layer, an Li 2 layer, and a transition metal 2 layer.

The crystal structure of the O6-type structure is a crystal structure belonging to the space group R-3m, in which lithium is present at the center of an oxygen octahedron, and six types of overlap between oxygen and a transition metal are present per unit cell. It is preferably a crystal structure in which one period is formed by an O 12 layer, an Me 6 layer, and an Li 6 layer.

### Layer Structure

In the positive electrode active material of the present disclosure, the layer_{O3} and the layer_{O2} are alternately laminated.

“The layer_{O3} and the layer_{O2} are alternately laminated” means that at least two layers_{O3} or layers_{O2} are included, and that between two layers, which are the layers_{O3} or the layers_{O2}, a layer that is different from the two layers (the layer_{O2} or the layer_{O3}) is provided (for example, in a case in which the two layers are the layers_{O3}, the layer_{O2}, which is the different layer, is provided between the two layers_{O3}).

From the viewpoint of the quick charging/discharging performance and the discharge capacity, the number of the layers_{O3} contained in one primary particle of the positive electrode active material according to the present disclosure is not particularly limited, but is preferably 3 layers or more and 400 layers or less, more preferably 10 layers or more and 300 layers or less, and still more preferably 50 layers or more and 300 layers or less.

From the viewpoint of the quick charging/discharging performance and the discharge capacity, the number of the layers_{O2} contained in one primary particle of the positive electrode active material according to the present disclosure is not particularly limited, but is preferably 3 layers or more and 40 layers or less, more preferably 4 layers or more and 30 layers or less, and still more preferably 5 layers or more and 25 layers or less.

Method for determining Layer_{O3} and Layer_{O2}

The layer_{O3} and the layer_{O2} included in the positive electrode active material are determined as follows.

Using a transmission-type electron microscope, the positive electrode active material is observed by annular bright field scanning transmission electron microscopy (ABF-STEM) under conditions of an acceleration voltage of 200 kV or more and a resolving power of 0.2 nm or less. Then, an interface between a region in which a structure that is consistent as the space group P63mc is observed and a region in which a structure that is consistent as the space group R-3m is observed is designated as an interface between the layer_{O3} and the layer_{O2} (hereinafter, this interface is referred to as a “layer_{O3}/layer_{O2} interface”). Then, in a case in which there is a region N, in which a structure that does not apply to either of the space group P63mc or the space group R-3m is observed, between the region in which the structure that is consistent as the space group p63mc is observed and the region in which the structure that is consistent as the space group R-3m is observed, an intermediate point of the region N is designated as the layer_{O3}/layer_{O2} interface. Then, the region in which the structure that is consistent as the space group P63mc is observed and a region from one end of the region N to the layer_{O3}/layer_{O2} interface are designated as the layer_{O3}, and the region in which the structure that is consistent as the space group R-3m is observed and a region from the other end of the region N to the layer_{O3}/layer_{O2} interface are designated as the layer_{O2}.

From the viewpoint of the quick charging/discharging performance and the discharge capacity, the volume of the layer_{O2} relative to the total volume of the layer_{O3} and the layer_{O2} (hereinafter, also referred to as the “specific volume ratio”) is 0.1 or more and 0.6 or less, preferably 0.2 or more and less than 0.6, more preferably 0.2 or more and 0.5 or less, and still more preferably 0.3 or more and 0.4 or less.

### Method for Calculating Specific Volume Ratio

The specific volume ratio is calculated by dividing “the volume of the layer_{O2}” by “the sum of the volumes of the layer_{O3} and the layer_{O2}”.

The volume of the layer_{O3} is measured as follows.

From an ABF-STEM image of <001> electron incidence obtained in a range of 10 nm×10 nm, (square of the long side)×(short side) is found for the regions determined as the layers_{O3}, the sum thereof for the entire region of the ABF-STEM image is taken, and the sums taken for 10 ABF-STEM images is designated as the volume of the layers_{O3}.

The volume of the layer_{O2} is measured as follows.

From an ABF-STEM image of <001> electron incidence obtained in a range of 10 nm×10 nm, (square of the long side)×(short side) is found for the regions determined as the layers_{O2}, the sum thereof for the entire region of the ABF-STEM image is taken, and the sums taken for 10 ABF-STEM images is designated as the volume of the layers_{O2}.

Properties of Positive Electrode Active Material From the viewpoint of the quick charging/discharging performance and the discharge capacity, in the positive electrode active material according to the present disclosure, an average value of intensities at all midpoints between two adjacent peaks with respect to an average value of all peak maximum intensities in an intensity profile obtained by integrating respective pixel values in a direction perpendicular to a c-axis in a high-angle annular dark-field scanning transmission electron microscope image with an electron beam incidence direction being set as <1-10> (hereinafter, also referred to as the “specific intensity ratio”) is preferably 0.05 or less, more preferably 0.01 or more and 0.05 or less, and still more preferably 0.01 or more and 0.03 or less.

### Method for Measuring Specific Intensity Ratio

The specific intensity ratio is measured as follows.

At a position 10 nm or more away from a particle surface of the positive electrode active material, using a transmission-type electron microscope, in a state in which a resolving power is 0.2 nm or less, an electron beam incidence direction is set as <1-10> to acquire a high-angle annular dark-field scanning transmission electron microscope (HAADF-STEM) image in a region of 10 nm×10 nm with a resolution of 512×512 or more. It should be noted that a HAADF-STEM image is acquired under the same conditions in a vacuum region without measurement data in advance, and the root mean square of background noise thereof is obtained. A result of subtracting the root mean square from the maximum intensity of the obtained HAADF-STEM image and further dividing this by the root mean square is defined as an S/N ratio, and the image is acquired so that the S/N ratio thereof is 100 or more. However, the image is obtained such that the maximum intensity of the obtained HAADF-STEM image does not reach a maximum value of the image, which is 225 in the case of an 8-bit image, 65535 in the case of a 16-bit image, and the like, and the HAADF-STEM image is acquired without performing nonlinear correction of a gamma value or the like. Furthermore, the following processing is carried out in a state in which correction is not performed on the obtained HAADF-STEM image.

An intensity profile is obtained by integrating the respective pixel values of the HAADF-STEM image in a direction perpendicular to the c-axis for 2 nm or more. For peaks with a period of about 0.48 nm appearing in the intensity profile, the maximum intensities of the peaks are calculated, and the arithmetic average value thereof is calculated to thereby calculate “the average value of the respective peak maximum intensities”. Then, the intensities at the midpoints between two adjacent peaks are calculated, and the arithmetic average value thereof is calculated to thereby calculate “the average value of the intensities at the midpoints between two adjacent peaks”. A ratio of “the average value of the intensities at the midpoints between two adjacent peaks” to “the average value of the respective peak maximum intensities” is calculated to thereby calculate the “specific intensity ratio”.

### Composition Formula of Positive Electrode Active Material

The composition of the positive electrode active material according to the present disclosure may be different or may be the same in the layer_{O3} and the layer_{O2}. From the viewpoint of the quick charging/discharging performance and the discharge capacity, the composition of the layer_{O3} and the layer_{O2} is preferably the same.

From the viewpoint of the quick charging/discharging performance and the discharge capacity, the positive electrode active material according to the present disclosure is preferably a compound represented by the following Formula 1.

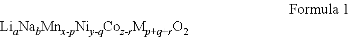

In the above Formula 1, a, b, x, y, z, p, q and r are numbers satisfying 0≤a≤1 (preferably 0.6≤a≤1), 0≤b≤0.05 (preferably 0≤b≤0.01), x+y+z=1, and 0≤p+q+r≤0.20 (preferably 0<p+q+r≤0.10), and M represents at least one selected from the group consisting of B, Mg, Al, K, Ca, Ti, Cr, Ga, Zr, Nb, Mo and W.

M preferably represents at least one selected from the group consisting of B, Mg, Al, K, Ca, Ti, Cr, Ga, Zr, Nb, Mo and W, and more preferably represents Al.

is preferably a number satisfying 0≤x≤1, and more preferably a number satisfying 0.1<x<1.

y is preferably a number satisfying 0≤y≤0.5, and more preferably a number satisfying 0≤y≤0.33.

z is preferably a number satisfying 0≤z≤1, and more preferably a number satisfying 0≤z≤0.67.

p is preferably a number satisfying 0≤p≤0.10.

q is preferably a number satisfying 0≤q≤0.10.

r is preferably a number satisfying 0≤r≤0.10.

Specific examples of the composition formula of the positive electrode active material according to the present disclosure include Li_{0.82}Na₀Mn_{0.5}Ni_{0.2}Co_{0.3}O₂, Li_{1.0}Na₀Mn_{0.5}Ni_{0.2}Co_{0.3}O₂, Li_{0.9}Na_{0.05}Mn_{0.5}Ni_{0.2}Co_{0.3}O₂, Li_{0.9}Na₀Mn_{0.67}Ni_{0.33}Co₀O₂, Li_{0.9}Na₀Mn_{0.5}Ni_{0.2}Co_{0.2}Al_{0.1}O₂, Li_{0.9}Na₀Mn_{0.5}Ni_{0.1}Co_{0.3}Mg_{0.1}O₂ and the like.

Method for Producing Positive Electrode Active Material The method for producing the positive electrode active material according to the present disclosure has a step of ion-exchanging Na contained in a compound represented by the following Formula 2 with Li (ion exchange step).

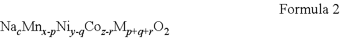

In the above Formula 2, c, x, y, z, p, q and r are numbers satisfying 0.82≤c, x+y+z=1, and 0≤p+q+r≤0.20.

M represents a metallic element selected from the group consisting of Li, B, Mg, Al, K, Ca, Ti, Cr, Ga, Zr, Nb, Mo and W.

c is preferably a number satisfying 0.82≤c≤1.05, and more preferably a number satisfying 0.82≤c≤1.00.

x is preferably a number satisfying 0≤x≤1, and more preferably a number satisfying 0.1≤x≤1.

y is preferably a number satisfying 0≤y≤0.5, and more preferably a number satisfying 0≤y≤0.33.

z is preferably a number satisfying 0≤z≤1, and more preferably a number satisfying 0≤z≤0.67.

p is preferably a number satisfying 0≤p≤0.10.

q is preferably a number satisfying 0≤q≤0.10.

r is preferably a number satisfying 0≤r≤0.10.

### Na-Doped Precursor Synthesis Step

The method for producing the positive electrode active material according to the present disclosure may include, if necessary, a step of synthesizing a compound represented by the above Formula 2 (hereinafter, also referred to as an Na-doped precursor). Furthermore, commercially available Na-doped precursors may be purchased and used. In the former case, the Na-doped precursors are synthesized by known methods. Specifically, it is preferable to use salts containing metals constituting the Na-doped precursors as raw materials, and to mix and react these salts.

Examples of the salts include, for example, sodium-containing carbonates, manganese-containing nitrates, nickel-containing nitrates, cobalt-containing nitrates, manganese-containing sulfates, nickel-containing sulfates, cobalt-containing sulfates, manganese-containing oxalates, nickel-containing oxalates, cobalt-containing oxalates, sodium-containing hydroxide salts, sodium-containing bicarbonates and the like.

Specific examples of the Na-doped precursor include Na_{0.82}Mn_{0.5}Ni_{0.2}Co_{0.3}O₂, Na_{1.0}Mn_{0.5}Ni_{0.2}Co_{0.3}O₂, Na_{0.9}Mn_{0.67}Ni_{0.33}Co₀O₂, Na_{0.9}Mn_{0.5}Ni_{0.2}Co_{0.2}Al_{0.1}O₂, Na_{0.9}Mn_{0.5}Ni_{0.1}Co_{0.3}Mg_{0.1}O₂, NaMnNiCoO₂ and the like.

### Ion Exchange Step

The ion exchange step is a step of ion-exchanging Na contained in the Na-doped precursor with Li. The ion exchanging of the Na-doped precursor can utilize a molten salt bed in which lithium nitrate and lithium chloride are mixed. A temperature condition at the time of the ion exchanging is preferably in a range of from a temperature at which the molten salt bed melts to less than 320° C.

### Solid-State Battery

A solid-state battery according to the present disclosure contains the positive electrode active material according to the present disclosure.

The solid-state battery according to the present disclosure preferably includes a positive electrode layer, a negative electrode layer, and an electrolyte layer or a separator arranged between the positive electrode layer and the negative electrode layer. The positive electrode layer contains the positive electrode active material of the present disclosure.

The solid-state battery includes a so-called all-solid-state battery in which an inorganic solid electrolyte is used as an electrolyte (a content of an electrolytic solution serving as the electrolyte is less than 10% by mass based on a total amount of the electrolyte).

### Positive Electrode Layer

The positive electrode layer contains the positive electrode active material according to the present disclosure, and may contain a conductivity aid, a solid electrolyte, a binder, and other components, if necessary.

Examples of the conductivity aid include, for example, carbon materials, metal materials, and conductive polymer materials.

As the solid electrolyte, a solid electrolyte contained in an electrolyte layer, which will be described later, can be used.

Examples of the binder include, for example, vinyl halide resins, rubbers, polyolefin resins and the like.

Examples of the other components include, for example, oxide solid electrolytes, halide solid electrolytes, thickeners, surfactants, dispersants, wetting agents, antifoaming agents, solvents and the like.

### Negative Electrode Layer

The negative electrode layer contains a negative electrode active material. The negative electrode layer may contain at least one of a solid electrolyte for a negative electrode, a conductivity aid, and a binder, if necessary. Examples of the negative electrode active material include Li-based active materials such as metallic lithium and the like, carbon-based active materials such as graphite and the like, oxide-based active materials such as lithium titanate and the like, and Si-based active materials such as Si simple substance and the like. As the conductivity aid, the solid electrolyte for a negative electrode, and the binder used for the negative electrode layer, the same ones as those contained in the positive electrode layer are applicable.

### Electrolyte Layer and Separator

The solid-state battery includes an electrolyte layer or a separator.

The electrolyte layer may be a layer containing a solid electrolyte.

In a case in which the electrolyte layer is a layer that contains a solid electrolyte (solid electrolyte layer), the solid electrolyte layer preferably contains one selected from the group consisting of a sulfide solid electrolyte, an oxide solid electrolyte, and a halide solid electrolyte.

As the separator, a porous sheet (film) composed of a resin such as polyethylene (PE), polypropylene (PP), polyester, cellulose, polyamide or the like can be used.

Positive Electrode Current Collector and Negative Electrode Current Collector The solid-state battery may further include a positive electrode current collector and a negative electrode current collector. The positive electrode current collector performs current collection for the positive electrode layer. The negative electrode current collector performs current collections for the negative electrode layer.

Examples of the positive electrode current collector include, for example, stainless steel, aluminum, copper, nickel, iron, titanium, carbon and the like, and aluminum alloy foil or aluminum foil is preferable.

Examples of the negative electrode current collector include, for example, stainless steel, aluminum, copper, nickel, iron, titanium, carbon and the like, and copper is preferable. Shapes of the positive electrode current collector and the negative electrode current collector are, for example, foil-shaped or mesh-shaped.

### Method for Producing Solid-State Battery

The method for producing the solid-state battery according to the present disclosure includes:
a step of preparing the positive electrode, the negative electrode, and the electrolyte layer (preparation step); and
a step of laminating the positive electrode, the electrolyte layer, and the negative electrode in this order (lamination step).

### Preparation Step

The preparation step is a step of preparing the positive electrode, the negative electrode, and the electrolyte layer or the separator.

The method for producing the positive electrode, the negative electrode, and the electrolyte layer is not particularly limited, and it is preferable to produce them by obtaining a slurry by kneading components that can be contained in the positive electrode layer, the negative electrode layer, and the electrolyte layer, followed by applying the slurry to a substrate, and pressing a dried film obtained by drying.

Examples of a method for pressing the dried film include roll pressing, cold isostatic pressing (CIP) and the like.

### Lamination Step

The lamination step is a step of laminating the positive electrode, the electrolyte layer or the separator, and the negative electrode in this order.

In the lamination step, it is preferable to obtain a laminated body (electrode body) by laminating the positive electrode, the electrolyte layer or the separator, and the negative electrode, which have been prepared in the preparation step, in this order, and, if necessary, carrying out pressing.

It is preferable to prepare the solid-state battery according to the present disclosure through the above steps.

### EXAMPLES

Examples are described below, but the present invention is not limited to these examples in any way. It should be noted that, in the following descriptions, unless otherwise specified, “part” and “%” are all based on mass.

### Example 1

### Na-Doped Precursor Synthesis Step

Mn(NO₃)₂·6H₂O, Ni(NO₃)₂·6H₂O, and Co(NO₃)₂·6H₂O were used as raw materials, and dissolved in pure water so that a molar ratio of Mn, Ni and Co was 5:2:3. A Na₂CO₃ solution with a concentration of 12% by mass was prepared, and these two solutions were simultaneously titrated into a beaker. At this time, a titration rate was controlled so that a pH was 7.0 or more and less than 7.1. After completion of the titration, the mixed solution was stirred at 50° C. and 300 rpm for 24 hours. The resulting reaction product was washed with pure water and only a precipitated powder was separated by centrifugation. The obtained powder was dried at 120° C. for 48 hours, and thereafter crushed in an agate mortar to obtain a powder (hereinafter, this powder is referred to as an “intermediate powder”).

To the obtained intermediate powder, Na₂CO₃ was added and mixed so that a compositional ratio was Na_{0.82}Mn_{0.5}Ni_{0.2}Co_{0.3}O₂. The mixed powder was pressed under a load of 2 tons by a cold isostatic pressing method to prepare pellets. The obtained pellets were subjected to prebaking in air at 600° C. for 6 hours and baking at 700° C. for 24 hours, and thereafter cooled to 250° C. at 3° C./min and allowed to cool to thereby synthesize an Na-doped precursor (Na_{0.82}Mn_{0.5}Ni_{0.2}Co_{0.3}O₂).

### Ion Exchange Step

LiNO₃ and LiCl were mixed at a mass ratio of 88:12 to obtain a mixed powder. Weighting was performed such that the ratio of the number of moles of Li contained in the mixed powder to the number of moles of the Na-doped precursor was tenfold. The Na-doped precursor and the mixed powder were mixed, and ion exchanging was performed in air at 280° C. for 1 hour. After the ion exchanging, water was added to dissolve the salt, and water washing was further performed to thereby obtain a positive electrode active material 1 (Li_{0.82}Mn_{0.50}Ni_{0.20}Co_{0.30}O₂) having a structure in which the layer_{O3} and the layer_{O2} were alternately laminated.

### Production of Solid-State Battery

### Preparation Step

### Preparation of Positive Electrode Layer

To 125 mL of a solvent n-methylpyrrolidone solution in which 5 g of polyvinylidene fluoride (PVDF) serving as a binder was dissolved, 85 g of the positive electrode active material 1 (that was ball-milled to form a powder) and 10 g of carbon black serving as a conductivity aid were introduced and kneaded until uniformly mixed to prepare a slurry. This slurry was applied on one face, with a basis weight of 6 mg/cm², of an Al positive electrode current collector having a thickness of 15 μm, serving as a substrate, and dried to obtain an electrode. Thereafter, the electrode was pressed to make a thickness of the positive electrode layer 45 μm and a density of the positive electrode layer 2.4 g/cm³. Finally, the electrode was cut out so as to have a diameter of 16 mm to obtain a positive electrode having a positive electrode layer and a positive electrode current collector.

### Preparation of Negative Electrode Layer

An Li foil was cut out so as to have a diameter of 19 mm to obtain a negative electrode layer.

### Preparation of Separator

A PP porous sheet was prepared as a separator.

Lamination Step The positive electrode, the separator, and the negative electrode layer were laminated in this order to obtain a laminated body. It should be noted that the positive electrode was laminated so that the positive electrode layer faced the separator. A CR2032-type coin cell battery was prepared by housing, in a coin cell, the laminated body and a nonaqueous electrolytic solution (a mixture of ethylene carbonate (EC) and dimethyl carbonate (DMC) with a volume ratio of 3:7, into which lithium hexafluorophosphate (LiPF₆), serving as a supporting salt, was dissolved at a concentration of 1 mol/L).

### Comparative Example 1

A positive electrode active material C1 and a CR2032-type coin cell battery using the positive electrode active material C1 were prepared in the same manner as in Example 1, except that an Na-doped precursor (Na_{0.75}Mn_{0.5}Ni_{0.2}Co_{0.3}O₂) was synthesized by changing the amount of Na₂CO₃ that was added to the intermediate powder in the “Na-doped precursor synthesis step”. The obtained positive electrode active material had a structure of O2 (P63mc), and did not have a structure in which a layer_{O3} and a layer_{O2} were alternately laminated.

### Comparative Example 2

A positive electrode active material C2 and a CR2032-type coin cell battery using the positive electrode active material C2 were prepared in the same manner as in Example 1, except that LiNO₃ and LiI were mixed at a weight ratio of 88:12 to obtain a mixed powder in the “ion exchange step”. Although the obtained positive electrode active material had a structure in which a layer_{O3} and a layer_{O2} were alternately laminated, the specific volume ratio was 0.81.

### Comparative Example 3

A positive electrode active material C3 and a CR2032-type coin cell battery using the positive electrode active material C3 were prepared in the same manner as in Example 1, except that an Na-doped precursor (Na_{1.00}Mn_{0.5}Ni_{0.2}Co_{0.3}O₂) was synthesized by adding Na₂CO₃ to the intermediate powder in the “Na-doped precursor synthesis step” such that the compositional ratio was Na_{1.00}Mn_{0.5}Ni_{0.2}Co_{0.3}O₂. Although the obtained positive electrode active material had a structure in which a layer_{O3} and a layer_{O2} were alternately laminated, the specific volume ratio was 0.08.

### Evaluation

### Laminated Structure, Specific Volume Ratio and Specific Intensity Ratio

For the positive electrode active material that was obtained in each example, it was determined whether or not a layer_{O3} and a layer_{O2} were alternately laminated, according to the “method for determining layer_{O3} and layer_{O2}” described above. In a case in which they were alternately laminated, “O3/O2 mixed phase” is indicated in Table 1, and in a case in which the structure consisted of only at least one type of crystal structure selected from the group consisting of the O2-type structure, the T #2-type structure, and the O6-type structure, “O2 single phase” is indicated in Table 1.

The specific volume ratio of the positive electrode active material obtained in each example was measured according to the “method for calculating specific volume ratio” described above. The results thereof are shown in Table 1.

The specific intensity ratio of the positive electrode active material obtained in each example was measured according to the “method for measuring specific intensity ratio” described above. The results thereof are shown in Table 1.

### Initial Discharge Capacity

Charge/discharge tests were conducted using a galvanostat under conditions of a current of 0.1 C, a charge termination voltage of 4.8 V, and a discharge termination voltage of 2.0 V. Starting from charging, after the first charging was completed, an amount of current required for discharging to 2.0 V was calculated, and the initial discharge capacity was calculated by dividing by the weight of the active material used for the measurement.

### Discharge Capacity at 5 C

Charge/discharge tests were conducted using a galvanostat under conditions of a current of 5 C. a charge termination voltage of 4.8 V, and a discharge termination voltage of 2.0 V. Starting from charging, after the first charging was completed, an amount of current required for discharging to 2.0 V was calculated, and the discharge capacity at 5 C was calculated by dividing by the weight of the active material used for the measurement.

Capacity Retention Rate after 50 Cycles

Charge/discharge tests were conducted under the same conditions as for the initial discharge capacity, and the first discharge capacity and the 50th discharge capacity were calculated. The 50th discharge capacity was divided by the first discharge capacity to obtain the capacity retention rate after 50 cycles.

TABLE 1

| | | | | | | Capacity |
|---|---|---|---|---|---|---|
| | | | | Initial | Discharge | Retention |
| | | Specific Volume Ratio | Specific | Discharge | Capacity | Rate after |
| | Laminated | [layer02/(layer02 + | Intensity | Capacity | at 5 C | 50 Cycles |
| | Structure | layer03)] | Ratio | (mAh/g) | (mAh/g) | (%) |
| Example 1 | O3/O2 | 0.34 | 0.01 | 213 | 175 | 93 |
| | mixed phase | | | | | |
| Comparative | O2 single | 1 | 0.02 | 216 | 119 | 95 |
| Example 1 | phase | | | | | |
| Comparative | O3/O2 | 0.81 | 0.12 | 199 | 131 | 81 |
| Example 2 | mixed phase | | | | | |
| Comparative | O3/O2 | 0.08 | 0.01 | 221 | 195 | 65 |
| Example 3 | mixed phase | | | | | |

From the above results, it can be understood that the positive electrode active material of the present example is a positive electrode active material, with which a battery having excellent quick charging/discharging performance and having a large discharge capacity in a region including a high potential region can be obtained.

What is claimed is:

1. A positive electrode active material in which a layer_{O3} having a crystal structure of an O3-type structure and a layer_{O2} having at least one type of crystal structure selected from the group consisting of an O2-type structure, a T #2-type structure, and an O6-type structure are alternately laminated,
wherein a volume of the layer_{O2} with respect to a total volume of the layer_{O3} and the layer_{O2} is 0.1 or more and 0.6 or less.

2. The positive electrode active material according to claim 1, wherein an average value of intensities at all midpoints between two adjacent peaks with respect to an average value of all peak maximum intensities in an intensity profile obtained by integrating respective pixel values in a direction perpendicular to a c-axis in a high-angle annular dark-field scanning transmission electron microscope image with an electron beam incidence direction being set as <1-10> is 0.05 or less.

3. A solid-state battery comprising the positive electrode active material according to claim 1.

4. A method for producing a positive electrode active material, the method comprising:
ion-exchanging Na contained in a compound represented by the following Formula 2 with Li: 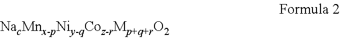
wherein, in Formula 2:
c, x, y, z, p, q and r are numbers satisfying 0.82≤c, x+y+z=1, and 0≤p+q+r≤0.20, and
M represents a metallic element selected from the group consisting of Li, B, Mg, Al, K, Ca, Ti, Cr, Ga, Zr, Nb, Mo and W.
